(19) United States
(12) Patent Application Publication
(10) Pub. No.: US 2003/0071168 A1
(43) Pub. Date: Apr. 17, 2003

(54) Collapsible airship batten assembly

(76) Inventor: Alfred C. Barnes III, San Marcos, CA (US)

Correspondence Address: HIGGS, FLETCHER & MACK LLP, 2600 FIRST NATIONAL BANK BUILDING, 401 WEST "A" STREET, SAN DIEGO, CA, 92101-7910, US

(21) Appl. No.: 09/978,145

(22) Filed: Oct. 15, 2001

(51) Int. Cl. B64B 1/02; B64B 1/06

(52) U.S. Cl. 244/30

(57) ABSTRACT

When this new and unique folding nose batten assembly is incorporated on the dirigible style of hot air airships so that they can easily be folded up and stored, it will mean that small airships will be no longer be held to operating out of airfields. They could take off from a small area with a mooring station having a storage building no bigger than a garage to keep the fabric out of the weather. Another convenience would include the unique ability of flying to and from the top of tall buildings. Many of these small airships could operate for a fraction of the cost of a single large gas filled airship. The advertising industry could use vast numbers of these air ships saving the cost of transporting large airships and crews to various locations. If there were no airships of this kind in the area it would be easy to have any number trucked in, still at a great savings. There is a large market in the recreational flyer, as in the conventional hot air balloons, except that they would not be at the mercy of the wind as where to land. They could take off and land at the same location if desired, possibly having a telescoping mooring tower in the driveway of their home and storing the airship in the garage.

### FIELD OF THE INVENTION

This invention relates to a new and unique collapsible device incorporated into the nose of a hot air balloon or airship whereby it has the distinct shape of a dirigible. That is an airship having a cylindrical cigar shape, motor driven, steered by the vertical and horizontal stabilizers, with a cabin underneath. This device is for structural support and for battening or tethering the airship while in the close proximity to the ground or a mooring tower. Additionally this device has the unique capability of retaining the sealed integrity of the container while being inflated and also able to fold in an umbrella fashion during deflation and storage, while remaining an integral part of the airship assembly.

### BACKGROUND OF THE INVENTION

Hot air balloons have been of a great interest since the Montgolfier brothers first invented them in 1783, where they made large cloth bags filled with smoke to fly over the city of Paris, France. For many years these balloons have taken the conventional spherical shape tapering at the base to the area called the appendix, where the heated air is inserted. The passenger basket is attached to the bag by a network of ropes and is usually made of wicker because such a framework is lightweight. The ballast is released during the flight to allow the balloon to rise in the air and a valve on the top allows the operator to release amounts of heated air to bring it down. A propane burner supplies the heated air to lift the present day balloons. This type of balloon is generally not self-propelled, has no aerodynamic shape or directional controlling surfaces. In the past few years these types of balloons have taken on many unconventional shapes, including cartoon characters and advertising shapes. Gas filled larger airships or dirigibles are cylindrically shaped with controlling surfaces, a cabin and passenger compartment and driven by means of an airplane engine and propellers.

With the large amount of money spent in the advertising industry, the inventor has devised a method whereby the hot air balloon can be used for advertising purposes. He has designed a hot air balloon in the shape of the conventional gas filled dirigible with an aerodynamic cigar shape, controlling surfaces, a pilot cabin and driven with an airplane engine and propeller. A propane burner will supply the hot air for lifting this airship and will be more economical to operate and maintain than the gas filled dirigibles due to the fact that it does not use helium gas as a lifting means and does not have to be stored in a large hanger. Though this shape and design of airship is not truly unique, the inventor has found a need for a light weight, folding or collapsible device for battening or tethering of the airship prior to or after each flight. The hot air bags, even when in the shape of a dirigible, have no rigid structure for attachment so there is a great risk that the air bag may be torn open or damaged while trying to restrain the airship. Those few with any form of nose battening or tethering means have endeavored to retain a rigid structure that makes the airbag cumbersome, heavy, and vulnerable when landing or deflating.

The unique umbrella like folding capability of this invention allows it to collapse as the air is released from the containment chamber in the deflation process, keeping it from being damaged. When the airship is inflated the device distributes the attachment forces through the entire nose section of the airship.

It has been found through the endeavors of the inventor and the patent search, that there is no apparatus on the market and no apparent patents that have similar characteristics to the unique airship folding battening assembly devised by this inventor.

For example, U.S. Pat. No. 1,007,405 by Rudolf Wagner et al. describes a complete framework for a gas airship that is of great strength and which enables the operator to remain in flight as long as possible. The airship described within this patent was constructed with a structural metal framework which would make it impracticable in hot air airship applications.

Pat. No. 1,505,135 by Ludwig Durr teaches of a invention that refers to airships and more especially, to airships of the rigid type, comprising a plurality of gas chambers and its' particular object is a novel system of stiffening the outer envelopes of the gas chambers. This is another patent that relates to the structural elements of a rigid airship only.

No prior art teaches or suggests the particular novelty of the airship folding nose batten assembly.

### SUMMARY OF THE INVENTION

An object of this invention is to supply a device that will support and protect the nose of an airship when it is attached to a mooring station.

Another object of this invention is to supply a device that will disperse the stresses involved, while restraining an airship, through a large area nose section of the fabric containment chamber.

Yet another object of this invention is to supply a collapsible, umbrella like battening assembly, for the nose of an airship.

Another object of this invention is to supply a foldable, lightweight battening assembly for ease of handling and storage.

Still another object of this invention is to create a means of sealing the fabric containment chamber while supplying an airship battening assembly.

Yet another object of this invention is to create an airship that can collapse into a small space and be easily transported, not requiring a large hanger.

A final object of the invention is to create a lightweight battening assembly that will be an integral part of the airship.

These and other objects, features and advantages of the invention will become apparent from the following summary when taken with the accompanying drawing figures. The present invention accomplishes its desired objects by providing a unique airship folding nose batten assembly, being an integral part of, but not limited to, a hot air airship that will freely collapse when being deflated in an umbrella like fashion, eliminating undo damage to the fabric enclosure. This folding nose batten assembly will work equally well in the disclosed configuration on a gas filled airship. In the folded configuration of the nose batten, the airship is easily transported and stored in a small space, not requiring a large hanger for storage. Though the nose batten must be considered an integral part of the airship it must also be understood that with some minor disassembly it can be easily removed.

The batten assembly is attached to the airship fabric containment chamber in part by a plurality of pockets sewn into the fabric nose section, housing the flexible spar extension tubes. Each spar extension tube is connected to the adjoining spar by means of flexible polyurethane joints with integrally encased coil compression springs, giving the joints added strength and flexibility. The spars translate inwardly to connect to the forward attachment member, by means of an adjustable swivel tie-rod end. A pair of locking nuts makes the adjustment in the length on the thread of the tie-rod end retaining it in a cavity in the forward attachment member. The forward attachment member is affixed to the batten plate assembly that rides up and down the central beam by means of teflon pads, allowing it and all the spars to slide freely between stops. The central beam has a series of holes along all sides notably called lightning holes, for the purpose of weight reduction. The forward stop is a piece of angle attached to the front of the central beam on one of the flat sides. The abaft stop is similar to the forward attachment member, but fixed rigidly on the end of the central beam. A plurality of spreader rods emanate out from the abaft attachment member to be hingeably connected to the spar ends.

The spreader rods connect to the abaft attachment member with the same adjustable swivel, tie-rod ends, and double nut attachment means. A hinge pin and bracket attached to the spar, allows the spreader rods to pivot as the apparatus is opened or collapsed. The hinge brackets are attached to the spars by means of a nut and bolt combination. These connection points are also used to attach the fabric skin of the containment chamber by having the bolt go through an orifice in the skin before entering the hinge bracket, thus sandwiching the fabric tightly and forming an effective sealing means. On the outside of the spar, the ornamental fabric nose cover is attached through a similar orifice, under the nut.

The nose section of the fabric skin or containment chamber, forward of the attachment points on the spars, forms an orifice around the central beam, there to translate abaft retaining the beam in a bellows or accordion pleated section attached to the abaft attachment member, forming an effective seal. This bellows section allows that with expansion and contraction of the assembly there is no damage to the fabric skin or sealing means.

The forward attachment member has a batten plate assembly with externally mounted segments having lightning holes and conforming to the contours of the airship. The batten plate assembly has one or more battening brackets securely fixed to the batten plate, along with angle gussets. Battening brackets and gussets are assembled with additional mounting plates forming the area for the central beam to slide through. Four teflon pads form the sliding means whereby the assembly moves smoothly along the box beam. The battening brackets are the attaching points when the airship is being held in a mooring position. The ornamental fabric nose cover fits tightly over the batten plate with a square orifice for the central beam and slots for the battening brackets. A decorative plastic or fiberglass nose cone covers the end with only the central box member protruding through to be attached thereto.

All the spar ends are tied together by a network of lines comprised of cording or cable. Each spar has two lines going to the opposite side of the assembly, not attaching to the spar at 180 degrees, but to the two spar ends adjacent to the spar at 180 degrees. The purpose of this line network is to retain the continuity of the structure during opening or closing.

### BRIEF DESCRIPTION OF THE DRAWINGS

These accompanying drawings, which are incorporated in and form a part of this specification, illustrate embodiments of the invention and together with the description, serve to explain the principles of the invention.

FIG. 1 is the side view of a dirigible style of airship incorporating the unique folding nose battening assembly.

FIG. 2 is a cross section through the folding nose battening assembly and the nose of the airship, with areas broken out to display internal parts.

FIG. 3 is a view taken through the spar showing the spreader rod and hinge bracket.

FIG. 4 is a view through the spar extension tube and airship fabric skin showing a typical pocket.

FIG. 5 is a perspective view of a deployed folding nose battening assembly displaying the line network configuration and nose cone.

FIG. 6 is an end view of the central beam and battening plate assembly.

FIG. 7 is a side view of the central beam and battening plate assembly.

FIG. 8 is a perspective view of a folded nose battening assembly.

FIG. 9 is a side view of the flexible joint between the spar and the spar extension, broken away to show the urethane joint and encapsulated compression spring.

FIG. 10 is an end view of the forward attachment member.

FIG. 11 is a cross section of the forward attachment member.

FIG. 12 is a cross section of the abaft attachment member with a cable attaching flange.

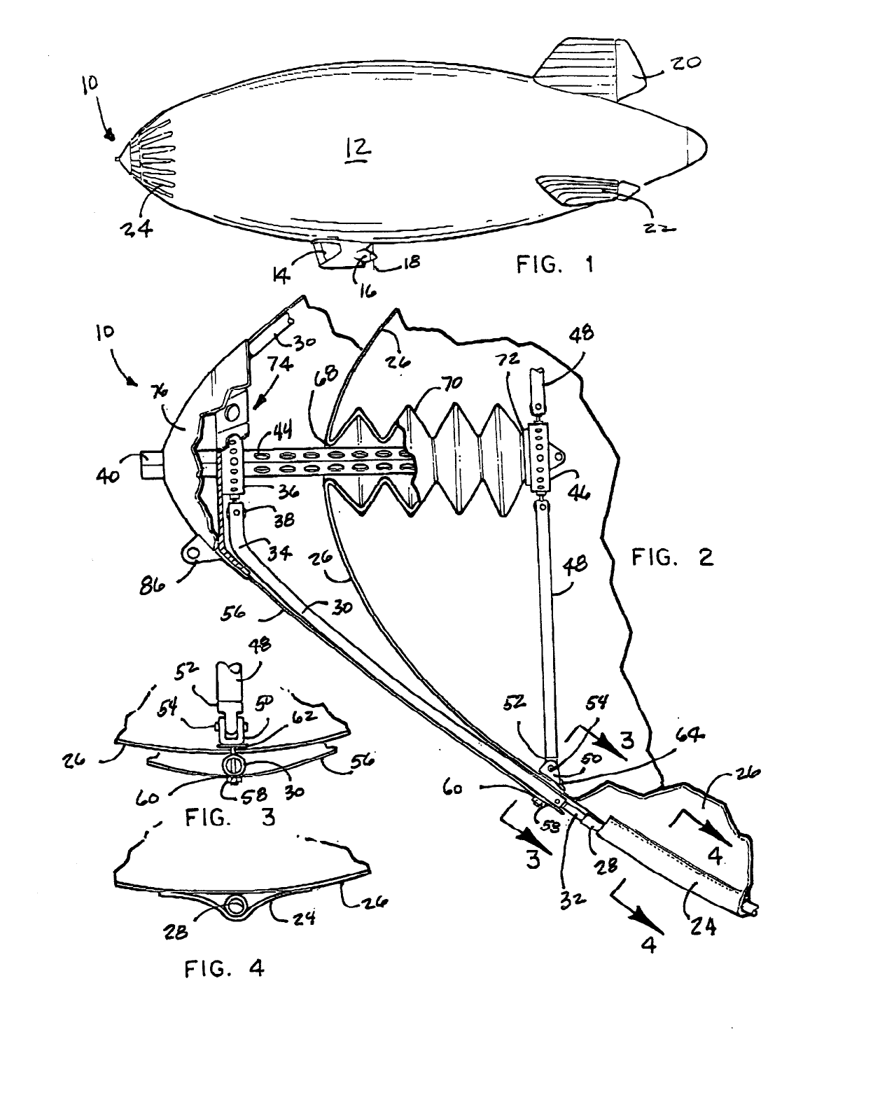

### DETAILED DESCRIPTION OF THE PREFERRED EMBODIMENT

Referring now to the drawing FIG. 1 that illustrates the folding nose batten assembly 10 installed on a dirigible style of airship 12, with the pilots cabin 14, airplane engine 16 and propeller 18, below the airship. The vertical stabilizer 20 and the horizontal stabilizers 22 control the steering while the lift is supplied by heated air or inert gas, with the use of ballast materials such as sand or water. The batten assembly is attached to the airship 10 in part by the means of pockets 24 sewn into the exterior fabric skin 26 where a plurality of spar extension tubes 28 are housed. The extension tubes are preferably made of kevlar due to its high strength and lightweight characteristics, although other materials known in the art may be used. Each spar extension tube 28 is connected to the adjoining spar by the means of a polyurethane joint 32. The spars 30 translate inwardly with a bend 34 to align each spar with the forward attachment member 36, connected by means of an adjustable swivel tie-rod end 38 to slide up and down the central beam 40 to facilitate the folding action of the device. The beam 40 is preferably a square tube with a piece of angle 42 attached to the forward end to act as a stop, a plurality of lightning holes along the flat surfaces with the abaft attachment member 46 rigidly affixed to the rear. A plurality of spreader rods 48 translate outwardly from the abaft attachment member to be connected to the spars 30, by means of a hinge brackets 50. Each spreader bar end 52 pivots on pivot pin 54 when the assembly is in the collapsing mode. The abaft attachment member 46 is attached to each spreader bar 48 by a adjustable swivel tie-rod end 38, as used in the forward attachment member 36. The means for attaching the hinge bracket 50 to the spar 30 also supplies the means to attach and seal the airship skin 26 to the assembly 10. Additionally, the ornamental fabric nose cover 56 uses the same attachment point. Bolt 58, attached to hinge bracket 50, passes through orifice 62 in the fabric skin 26, then through the spar 30 and through orifice 60 in the ornamental fabric nose cover 56 and held in place by nut 64.

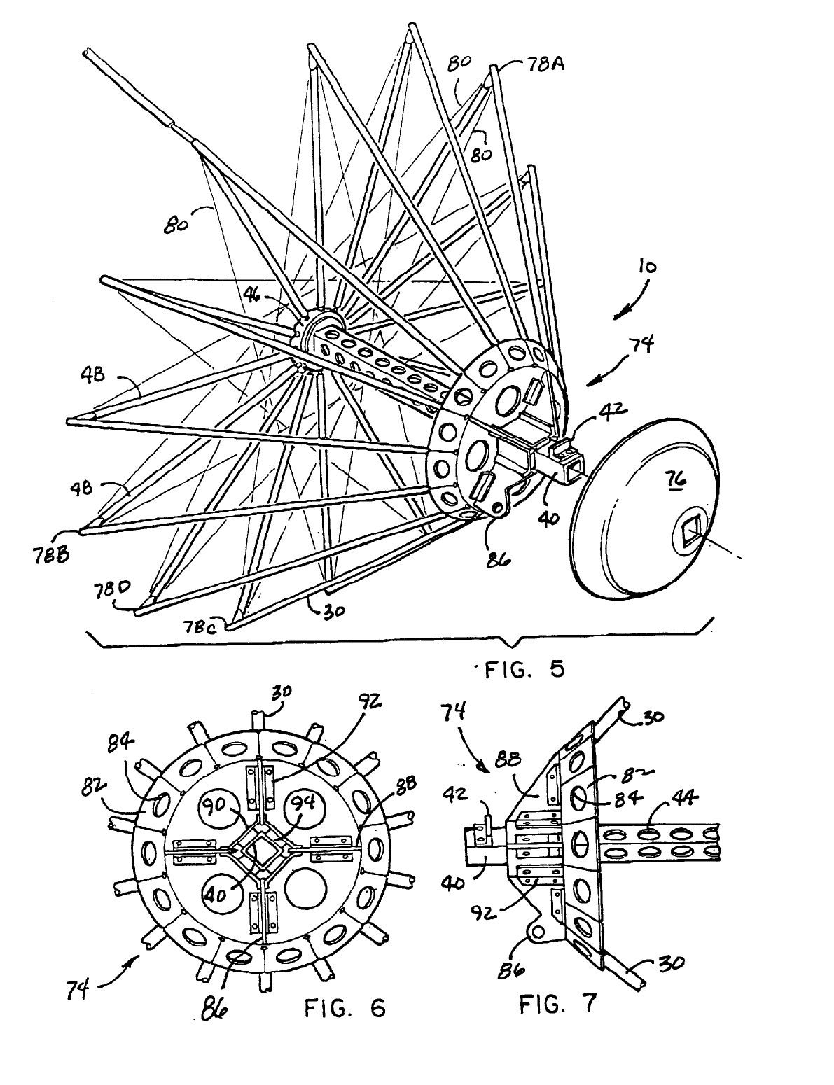

Nose section fabric skin 26 forms an orifice 68 around the central beam 40 and translates abaft through a bellows section 70 of the fabric skin 26. The bellows section 70 as drawn can be an integral part of the fabric skin 26, or may be a separate piece and made from a variety of flexible materials and attached to the fabric skin 26. The bellows section 70 is furthermore attached to abaft attachment member 46, forming an effective seal 72. Batten plate assembly 74 is fixed to forward attachment member 36 to be further described in FIG. 6. A plastic or fiberglass nose cone 76 covers the forward end of the assembly 10.

FIG. 3 is a view taken through the spar 30 showing the spreader rod end 52, the hinge bracket 50, hinge pin 54 and attachment bolt 58. FIG. 4 is a view through the kevlar spar extension tube 28 and the pocket 24 in the fabric skin 26.

FIG. 5 is a perspective view of the deployed folding nose battening mechanism 10 showing the plurality of spars 30 emanating out from the batten plate assembly 74 without showing the fabric skin 20, or the ornamental fabric nose cover 56. The nose cone 76 is projected away form the central beam 40 to display the location of the attached stop 42. All spar ends 78 are similarly tied together by a network of lines 80 comprised of cording or cable. Typically spar end 78A would be connected to two different spar ends 78B and 78C, both being on opposite sides of spar end 78D which is 180 degrees from spar end 78A. This same pairing will continue until all the spar ends 78 have been interconnected with lines 80.

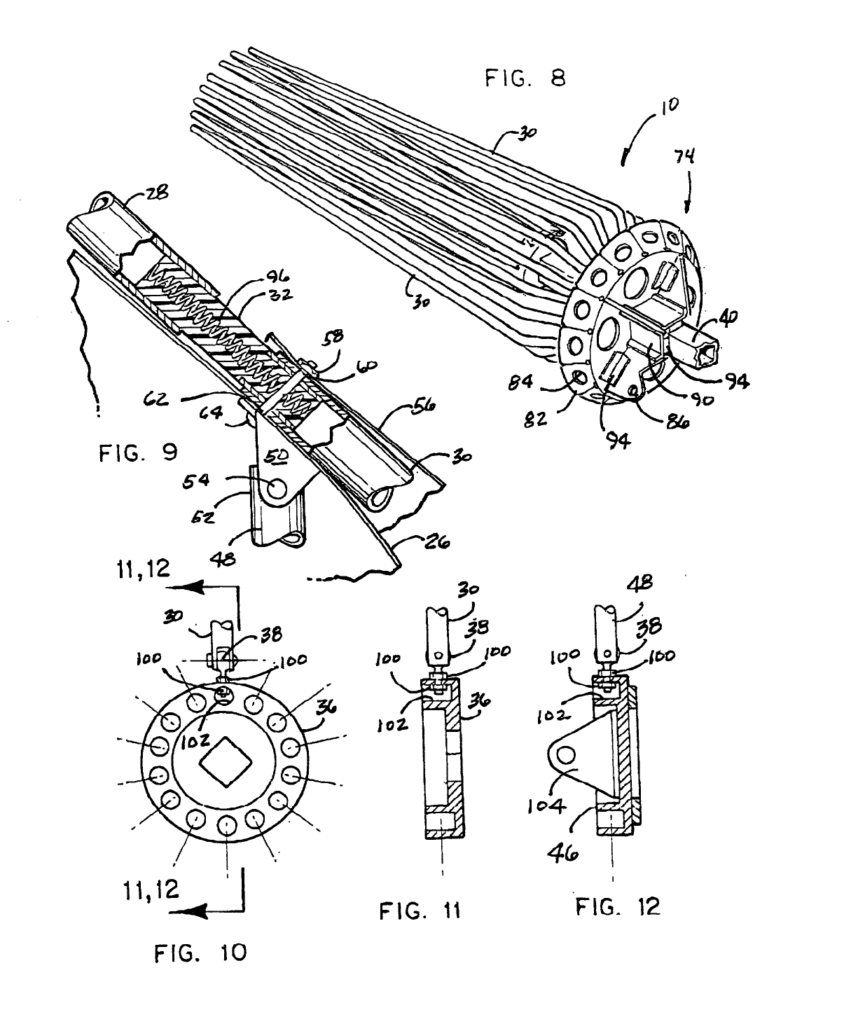

FIG. 6 illustrates a front view of the batten plate assembly 74 with typical sections 82, each having a lightning hole 84 and tapering back in the configuration of the airship 12. The batten plate has one or more battening brackets 86 and angle gussets 88, with four mounting plates 90, all held together with a series of angles 92. Within the mounting plates 90 are four teflon pads 94 forming a sliding means whereby the batten plate assembly will slide along central beam 40. Battening bracket 86 is the point of attachment for airship 12 to a mooring station. FIG. 8 is a perspective view of the folded nose battening assembly 10, without the fabric skin 26, the ornamental fabric nose cover 56, or the nose cone 76.

FIG. 9 is a side view of the flexible urethane joint 32, with the side removed to clarify the encased compression spring 96 and the sealing means of the fabric skin 26. FIG. 10 is an end view of attachment member 36 with a single spar 30 and adjustable swivel, tie-rod end 38 showing how the threaded end 98 is retained by two nuts 100 within orifice 102. FIG. 11 is a section through attachment member 36 further clarifying the attachment means of spar 30, onto orifice 102. FIG. 12 shows the similar attachment of the spreader rod 48 to the abaft attachment member 46, along with a cable attachment flange 104 to be optionally used to attach internal cables of the airship 12.

While the present invention has been described herein, with references to particular embodiments thereof, a latitude of modification, various changes and substitutions are intended in the foregoing disclosure and will be appreciated that in some instance, some features of the invention will be employed without a corresponding use of other features without departing from the scope of the invention as set forth.

I claim:

1. A dirigible style airship, comprising:
an inflatable containment chamber having first and second ends; and
a batten assembly attached to said first end of said chamber, wherein said assembly is opened in an umbrella like fashion upon inflation of said containment chamber, and wherein said assembly is freely collapsible as the air/gas is released from the containment chamber in the deflation process.

2. A dirigible style airship as recited in claim 1, wherein said batten assembly comprises:
a central beam having first and second ends;
a first attachment member rigidly affixed to said first beam end;
a first set of longitudinal rods having first and second ends, said first ends adjustably connected to and emanating out from said first attachment member;
a second attachment member slidably mounted on said central beam for movement along the length of said beam;
a second set of longitudinal rods each having first and second ends, said rods attached to the exterior of said inflatable containment chamber and adjustably connected to said first set of rods, said first ends of said rods translating inwardly to movably connect with said second attachment member; and
Wherein said movement of said second attachment member facilitates the expansion and collapsing of said batten assembly.

3. A dirigible style airship as recited in claim 1, wherein said first and second chamber ends are forward and abaft ends, respectively.

4. A dirigible style airship as recited in claim 2, wherein said first set of rods are hingibly connected to said second set of rods.

5. A dirigible style airship as recited in claim 2, wherein said first ends of said first set of longitudinal rods are pivotably/swivel connected to said first attachment member, and said first ends of said second set of rods are pivotably/swivel connected to said second attachment member.

6. A dirigible style airship as recited in claim 2, further comprising a set of extension rods attachably connected to said second ends of said second set of rods and positioned adjacent said exterior of said chamber.

7. A dirigible style airship as recited in claim 6, wherein said set of extension rods are attached to said second set of rods by way of a flexible joint.

8. A dirigible style airship as recited in claim 6, wherein said set of extension rods are attached to said containment chamber.

9. A dirigible style airship as recited in claim 1, wherein said containment chamber encloses a gas to provide lift to the airship.

10. A dirigible style airship as recited in claim 1, wherein said containment chamber encloses hot air to provide lift to the airship.

11. A dirigible style airship as recited in claim 1, further comprising a battening means mounted to said second attachment means for providing a way to tether the airship.

12. A dirigible style airship as recited in claim 2, wherein said second set of rods are attached to said first set of rods such that said inflatable containment chamber is sandwiched therebetween and thereby forming an effective seal.

13. A dirigible style airship as recited in claim 1, wherein said batten assembly is removable from said airship.

14. A batten assembly for use on a dirigible style airship, comprising:
a central beam having first and second ends;
a first attachment member rigidly affixed to said first end;
a first set of longitudinal rods having first and second ends, said first ends adjustably connected to and emanating out from said first attachment member;
a second attachment member slidably mounted on said central beam for movement along the length of said beam;
a second set of longitudinal rods each having first and second ends, said rods attached to the exterior of said inflatable containment chamber and adjustably connected to said first set of rods, said first ends of said rods translating inwardly to movably connect with said second attachment member; and
wherein said movement of said second attachment member facilitates the expansion and collapsing of said batten assembly.

15. A batten assembly as recited in claim 11, further comprising a forward stop mounted near said second end of said central beam.

16. A collapsible batten assembly for use on an airship, comprising:
a central longitudinal beam having forward and abaft ends;
a abaft attachment member rigidly affixed to said abaft end of said central beam;
a stop means positioned at said forward end of said central beam;
a forward attachment member mounted on said central beam for slidable movement between said abaft attachment member and said stop means to facilitate the folding action of the batten assembly;
a plurality of flexible longitudinal spars aligned with and connected to said forward attachment member for movement therewith;
a plurality of spreader rods adjustably connected between said plurality of spars and said abaft attachment member; and
an attachment means for mounting said batten assembly to the hull of an airship.
